(19) United States
(12) Patent Application Publication
(10) Pub. No.: US 2009/0201487 A1
(43) Pub. Date: Aug. 13, 2009

(54) MULTI SPECTRAL VISION SYSTEM

(75) Inventors: Michael P. Paluszek, Princeton, NJ (US); Pradeep Bhatta, Plainsboro, NJ (US)

Correspondence Address: FOX ROTHSCHILD LLP, P O BOX 592, 112 NASSAU STREET, PRINCETON, NJ, 08542-0592, US

(73) Assignee: PRINCETON SATELLITE SYSTEMS, INC., Princeton, NJ (US)

(21) Appl. No.: 12/193,190

(22) Filed: Aug. 18, 2008

Related U.S. Application Data
(60) Provisional application No. 60/956,420, filed on Aug. 17, 2007.

(51) Int. Cl. G01C 3/08

(52) U.S. Cl. 356/4.01

(57) ABSTRACT

A MultiSpectral Vision Sensor (MSVS) that employs three detectors which detect optical radiation in different frequency bands to permit target detection in a wide range of lighting conditions.

### CROSS REFERENCE TO RELATED APPLICATIONS

This application is related to, and claims priority from, U.S. provisional application 60/956,420 filed on Aug. 17, 2007 by M. Paluszek entitled “Multi-Spectral Vision System”, the contents of which are hereby incorporated by reference.

### STATEMENT REGARDING FEDERALLY SPONSORED RESEARCH OR DEVELOPMENT

This invention was made with Government support under Contract No. NAS8-03030 awarded by the National Aeronautics and Space Administration. The Government has certain rights in the invention.

### FIELD OF THE INVENTION

The present invention relates to detection of spacecraft using optical sensors, and particularly to detection using passive optical sensors that combine signal from different spectral regions.

### BACKGROUND OF THE INVENTION

Relative positioning and tracking are critical in automated navigation, collision avoidance, and highly accurate automated docking of unmanned micro shuttles to the docking module of satellites in orbit.

Many ladar and optical sensors have been developed for use by spacecraft for rendezvous and docking missions. Some of these are discussed briefly below. Sandia National Labs has, for instance, developed a scannerless rangefinder that can produce high density depth maps at high rates. The range imager apparently works by using a high-power laser diode to illuminate a target. The phase shift of the reflected light from the target relative to the AM carrier phase of the transmitted light is apparently measured to compute the range to the target. The gain of the image intensifier within the receiver is modulated at the same frequency as the transmitter. The light reaching the detector is typically dependent on the phase of the return signal and its intensity may also be dependent upon the reflectivity of the target. To normalize reflectivity variations the intensity of the return beam may be sampled twice, one with the receiver modulation gain disabled and once with the modulation on. Thus, the range associated with each pixel is essentially measured simultaneously across the entire scene. This is a relatively short range sensor (46-300 m) and is typically only suitable for inspection purposes. It also announces its presence through its laser which may be a concern in applications where stealth is required. It may also not be suitable for use with targets that have sensitive optics and that may, therefore, be damaged by illumination with a.

The LDRI is described in, for instance, U.S. Pat. No. 6,677,941 issued to Lin on Jan. 13, 2004 entitled “Three-dimensional relative positioning and tracking using LDRI”, the contents of which are hereby incorporated by reference.

The Rendezvous Radar (RVR) for Engineering Test Satellite seven (ETS-VII), launched by the National Space Development Agency of Japan (NASDA) on Nov. 28, 1997 to conduct the space robot technology experiments, is, apparently, an optical navigation sensor which will be used for distances from about 2 m to about 600 m. The RVR emits a 810 nm laser pulse and measures the reflected light from a cubed corner reflector. This is an extremely short range sensor and requires the target to be equipped with cubed corner reflectors, a major disadvantage.

Optech and MD Robotics have developed a Rendezvous Laser Vision System (RELAVIS) to address on-orbit servicing requirements. RELAVIS is similar to the commercially produced ILRIS-3D. Preliminary tests apparently demonstrate a maximum range of about 2.5 km with range accuracy of about 1 cm for the entire range and positional accuracy of about 2 cm. This sensor does not, apparently, require retroreflectors but because of its short range must be supplemented by other expensive sensors such as radar. It also requires a laser which may preclude stealth applications or targets that cannot be scanned by a laser.

Orbital Sciences has built the Advanced Video Guidance Sensor for use on the NASA DART mission. The sensor is apparently based on the Video Guidance Sensor (VGS) and Advanced Video Guidance Sensor (AVGS) developed by NASA/MSFC for use in space rendezvous and docking. The AVGS apparently fires lasers of two wavelengths, typically 800 nm and 850 nm at retroreflective targets on the chase vehicle. The retro-reflective targets are typically shielded with an optical filter that allows only the 850 nm wavelength laser to be reflected. Thus subtraction of the 800 nm image from the 850 nm image highlights the illuminated targets in all lighting conditions. AVGS software apparently generates centroids for each of the targets. The geometric arrangement of the targets may allow determination of relative position and orientation. The targets typically do not have to be in any specific pattern, aside from not being coplanar. At long range a set of widely-space targets may be used. A shorter range a cluster of targets may be used. This permits the use of the sensor at ranges of 100s of meters yet preserves precision at closer ranges. The accuracy ranges from 10 mm along the perpendicular and 0.75 deg at 5 m range to 3 mm along the perpendicular and 0.3 deg at less than 3 m. The AVGS/VGS system uses predefined points on the target. In addition, it employs controlled illumination to improve the detection of the points. This simplifies the video processing considerably at the expense of adding the lasers for illumination and retro-reflectors on the target vehicle. This device typically has limited range and requires retroreflectors on the target spacecraft.

U.S. Pat. No. 6,411,871 by Ching-Fang Line dated Jun. 25, 2002, the contents of which are hereby incorporated by reference, describes an autonomous navigation, guidance, and control process for docking and formation flying by utilizing a laser dynamic range imager (LDRI) and other known technologies, including, but not limited to, fuzzy logic based guidance and control, optical flow calculation, (typically including cross-correlation, phase-correlation, and image differential), software design and implementation, and typical verification methods. The autonomous navigation, guidance, and control process may include the steps of providing an expected reference position relative to a target; generating a carrier position and attitude relative to said target by a Range and Intensity Images Provider; producing a relative position and attitude error; and producing control commands from said relative position and attitude error for relative motion dynamics. As with the other devices it typically requires a laser to illuminate the target which may be a disadvantage in many applications.

### SUMMARY OF THE INVENTION

Briefly described, the invention provides a passive optical sensor called the Multi-Spectral Vision Sensor (MSVS). The sensor employs different frequency bands including visible and infrared to image other spacecraft.

The optical sensor of the present invention has significant advantages over the current art, most of which are active sensors requiring illuminating the target in some manner.

Using different frequency bands reduces the obscuring effects of, for instance, sunlight and therefore enabling reliable relative orientation and position determination possible in most lighting conditions. Another advantage over many other range the devices is that it does not require the addition of retroreflectors to the target spacecraft. This means that it can be used with any target spacecraft, including those already flying. It does not require scanning the target with a laser which means it may be used for targets that have sensitive optics or in situations where stealth may be required.

These and other features of the invention will be more fully understood by references to the following drawings.

### BRIEF DESCRIPTION OF THE DRAWINGS

FIG. 1 is shows a schematic drawing of a sensor of the present invention.

### DETAILED DESCRIPTION

The present invention relates to devices and methods for passive sensing or imaging of spacecraft that employ different frequency bands, including the visible and infrared frequency bands. Such optical sensor devices may be termed Multi-Spectral Vision Sensors (MSVS).

A preferred embodiment of the invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

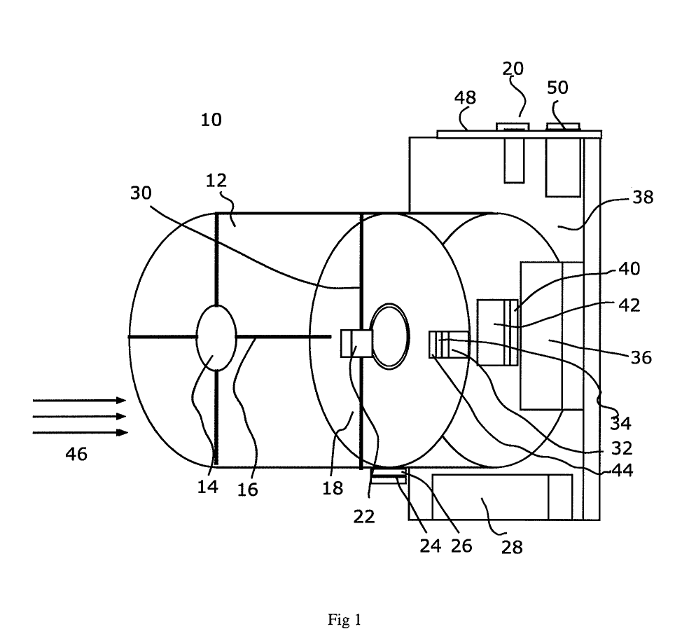

A preferred embodiment of a MultiSpectral Vision Sensor (MSVS) 10 is shown schematically in FIG. 1.

In a preferred embodiment, the MultiSpectral Vision Sensor (MSVS) 10 may include multiple sensors, including, but not limited to, an ultraviolet detector 26, an infrared detector 44 and a visible light CCD 42. The detectors may have individual support electronics in the form of an ultraviolet detector electronics module 24, an infrared detector electronics module 32 and a visible light CCD electronics module 40. The multi-spectral vision sensor 10 may also include a primary beamsplitter 22 and a telescope having imaging optics that may include a primary mirror 18 and a secondary mirror 14. The telescope may direct incoming electromagnetic radiation toward the primary beamsplitter 22. The multi-spectral vision sensor 10 may also have a signal processor 36 for processing data. The multi-spectral vision sensor 10 may also have a telescope housing 12 for housing the imaging optics and other components such as, but not limited to, secondary mirror supports 16 and primary beamsplitter supports 30. The multi-spectral vision sensor 10 may also have an electronics housing 48 that houses all the electronics including the signal processor 36 and the power supply 28. The electronics housing 48 may also have structures for connecting data to other components such as, but not limited to, an input/output plug 50 and a test connector 20.

In a preferred embodiment, the telescope housing 12 may extend from the telescope aperture to the baseplate 38. The secondary mirror 14 is typically located near the telescope aperture and may direct light from the primary mirror 18 to a focal point and through the primary beamsplitter 22.

The secondary mirror supports 16 typically connect the secondary mirror 14 to the telescope housing 12.

The primary mirror 18 may collect incoming light 46 and redirect the light towards the secondary mirror 14.

The electronics housing 48 houses all of the supporting electronics. All electronics typically have thermally conductive paths to the housing which then conducts heat to an external heat sink (not shown).

The test connector 20 may permits test inputs to be sent into the sensor.

The primary beamsplitter 22 may be used to split the incoming radiation among the three CCD detectors. The primary beamsplitter 22 may, for instance, separate electromagnetic radiation into a plurality of spectral bands and direct each spectral band to a discrete and separate location in space.

The primary beamsplitter supports 30 typically connect the primary beamsplitter 22 to the telescope housing 12.

The infrared detector electronics module 32 may process the signal from the infrared detector 44 prior to sending the signal to the signal processor 36.

The ultraviolet detector electronics module 24 may process the signal from the ultraviolet detector 26 prior to sending the signal to the signal processor 36.

The power supply 28 typically attaches to an external power source and produces the voltages needed by all of the devices.

The primary beamsplitter 22 typically attaches to the telescope housing 12.

The baseplate 38 may be connected to the electronics housing 48 and may provides structural support and a thermal path for all of the devices in the sensor.

The visible light CCD 42 may be a two dimensional array of CCD elements that measure optical energy reflected from the target. The visible light CCD electronics module 40 may read out the charge from the CCD chip and send it one frame at a time to the signal processor 36. The signal processor 36 may collects signal from the visible CCD electronics 40, infrared detector electronics 32 and ultraviolet detector electronics 24.

The input/output plug 50 may be the external interface for the sensor.

The incoming ambient light 46 typically enters via the telescope aperture.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

What is claimed:

1. An optical sensor for measuring relative position, velocity, attitude and attitude rate of a satellite, comprising:
a beamsplitter capable of separating electromagnetic radiation into a plurality of spectral bands and directing each spectral band to a discrete and separate location in space;
a telescope capable of directing incoming electromagnetic radiation toward said beamsplitter; and
a plurality of two-dimensional array imaging chips capable of imaging different spectral bands, and wherein each of said two-dimensional imaging chips is located at the location in space to which said beamsplitter has directed the corresponding spectral band;

2. The optical sensor of claim 1 comprising three or more of said two-dimensional array imaging chips.

3. The optical sensor of claim 1 wherein at least one of said two-dimensional array imaging chips is a charged coupled devices

4. The optical sensor of claim 1 wherein at least one of said two-dimensional array imaging chips is a charge injection device.

5. The optical sensor of claim wherein at least one of said two-dimensional array imaging chips is a complementary metal oxide semiconductor chip.
